(19) United States
(12) Patent Application Publication
(10) Pub. No.: US 2019/0244164 A1
(43) Pub. Date: Aug. 8, 2019

(54) PRODUCT RELATIONSHIP, RECOMMENDATION, AND INVENTORY MANAGEMENT SYSTEMS, METHODS, AND COMPUTER PROGRAM PRODUCTS

(71) Applicants: Joseph S. EMERT, Knoxville, TN (US); Clark E. CHARLTON, Hendersonville, TN (US); Joshua B. EMERT, Nashville, TN (US)

(72) Inventors: Joseph S. EMERT, Knoxville, TN (US); Clark E. CHARLTON, Hendersonville, TN (US); Joshua B. EMERT, Nashville, TN (US)

(21) Appl. No.: 16/316,512

(22) PCT Filed: Jul. 13, 2017
(86) PCT No.: PCT/US17/41925

§ 371 Date: Jan. 9, 2019

Related U.S. Application Data
(60) Provisional application No. 62/361,866, filed on Jul. 13, 2016.

(51) Int. Cl. G06Q 10/08; G06Q 30/06; G06Q 30/02

(52) U.S. Cl. CPC G06Q 10/087; G06Q 30/0201; G06Q 30/0631

(57) ABSTRACT

Systems, methods, and computer program products for web-based product relationship management, product recommendation, and product inventory management for the healthcare industry are described. The system (400; 500) and method (1400; 1500) includes uploading, displaying, and modifying product data from one or more medical device manufacturers. The system (400; 1500) and method (1400; 1500) includes relating products through user-created, criteria-based relation definitions by product type, and receiving product recommendations based on purchase history and/or usage statistics. The system (400; 500) and method (1400; 1500) includes managing inventory based on Automatic Identification and Data Capture (AIDC) tracking and scanning capable hardware.

### TECHNICAL FIELD

Embodiments disclosed herein generally relate to systems, methods, and computer program products for product relationship management, product recommendation, and product inventory management applicable to, for example, the healthcare industry.

### BACKGROUND

An important shift in commerce occurred as consumers were able to comparatively analyze products without the direct assistance of manufacturer sales and marketing teams through web-based ecommerce applications. Consumers today are not only quick to evaluate multiple products for their specific needs within a family of products offered by a single manufacturer, but also across various manufacturers thanks in large part to a standardization of design features, product attributes and ratings systems.

The healthcare industry, for example, lacks much of the transparency of product information found in common consumer-focused ecommerce applications online today, particularly regarding medical device product details, the relatedness of these products, as well as an effective means of providing product recommendations based on previous purchase habits and/or product usage within healthcare providers.

Whereas basic categorization may exist to distinguish between product type, such as a Stent vs a Defibrillator vs a Pedicle Screw, or other internal product categorization, this basic labeling fails to take into account the various product attribute and design features that may distinguish one product from another within a category.

In the healthcare industry, physician preference items (PPIs), such as hip and spine implants, defibrillators, pacemakers and hernia mesh, often make up a significant percentage, sometimes more than 50% of a hospital's supply expense. Based on a study by the Health Industry Distributors Association (HIDA.ORG) regarding administrative costs of purchasing PPIs for healthcare providers, the cost of purchasing PPIs and other medical supplies directly from manufacturers is more than three times more expensive than purchasing via distributors.

There are many contributing factors as to why purchasing medical supplies directly from manufacturers is costly and complex for healthcare providers, some of which include: (1) the lack of an integrated system for electronically purchasing medical products directly from all manufacturers; (2) lack of a systematic approach to compare, contrast, and relate physician preference items—resulting in manual, repetitive, and subjective analysis; (3) high labor costs associated with each manufacturer involved in the purchasing process—multiple touch point requiring manual analysis (request for proposals, discounts, rebates, and S2s); and (4) lack of automation in processing of reordering.

Similarly, the cost of contracting PPIs to healthcare providers is expensive for manufacturers, as well. According to Advamed's 2015 annual report, the average selling, general, and administrative (SG&A) expenses for medical device manufacturers represent 36% of total revenues on average. Furthermore, the cost of PPI inventory management is also costly for both healthcare providers and manufacturers. A paper published by GHX titled “The Current State of Implantable Device Supply Chain,” states that “[l]ack of visibility and control over these [medical] devices costs the healthcare industry an estimated $5 billion per year from inefficient, disconnected manual processes, and lost, expired and wasted products.”

Accordingly, healthcare providers purchasing medical devices desperately need a technological solution to enable them to make unbiased purchasing decisions without the influence of medical device manufacturer sales and marketing organizations. Furthermore, medical device manufacturers negotiating purchasing contracts to align to business objectives desperately need a technological solution to provide for analysis of potential impact based on current or previous healthcare provider usage.

### SUMMARY

Particular embodiments of the present invention are directed to systems, methods, and computer program products for web-based applications employing user interaction and Automatic Identification and Data Capture (AIDC) technologies enabling product relationship, product recommendation and product inventory management for the healthcare industry.

In particular, embodiments of the systems, methods, and computer program products include methods for relating products through user-defined formulas on a product type level; methods for information processing to assist users in evaluating recommended products derived from an analysis of purchase histories and/or usage statistics; and methods for asset control and security systems for tracking products leaving one location or person, among others.

According to one exemplary embodiment, a web-based application enables healthcare providers a method to upload, manage, display and order medical device manufacturer products and product data, create criteria-based definitions to relate products within a product type classification, and discover product recommendations to help make more cost-effective purchasing decisions without sacrificing necessary product design features used previously.

According to another exemplary embodiment, the systems, methods and computer program products described herein enable medical device manufacturers a method to upload, manage and display their own and competitive product data, create criteria-based definitions to relate products within a product type classification, and cross-reference competitive products to their own products to identify gaps in their technology offering and create comprehensive strategic proposals to gain additional market share proactively or in reaction to a healthcare provider request for proposal using category, capitation pricing matrix, or bundled payment procedure contracting strategies.

According to another exemplary embodiment, the systems, methods and computer program products described herein provide, for both healthcare providers and medical device manufacturers, an inventory tracking system that agnostically utilizes any first-party or third-party Automatic Identification and Data Capture (AIDC) tracking technologies and AIDC scanning hardware or similar active or passive unique scanning technology or methods via application program interfaces (APIs) to trace unique products uploaded to the system on an individual level as they reside in and travel between AIDC scanning hardware locations and personnel granted access to these AIDC scanning hardware locations.

According to another exemplary embodiment, the systems, methods and computer program products described herein track the usage of products being tracked through usage confirmation forms. The utilization of the granular data sets for AIDC tracking of products provided enables unparalleled search and discovery opportunity as well as usage information that is not present in applications today.

According to another exemplary embodiment, the systems, methods and computer program products described herein include: uploading, storing, modifying, searching, and/or filtering product data in the cloud.

According to another exemplary embodiment, the systems, methods and computer program products described herein include: relating products, providing product recommendations, tracking products between physical locations and personnel using automated identification and data capture (AIDC) technology, reporting usage of tracked products, and ordering products and/or automatically issuing reorders of products.

In one particular aspect, a computerized method for product relationship, recommendation, and inventory management is disclosed. The computerized method comprises the steps of: providing a graphical user interface to a user via an application server; receiving a first product data provided by the user via the graphical user interface, wherein the first product data includes a first list of one or more attributes of a first product, and wherein each attribute is associated with predefined classifications; comparing the first list of one or more attributes of the first product with a plurality of lists of one or more attributes for a plurality of product data stored in one or more databases; automatically relating the first product data with at least one or more of the plurality of product data stored in the one or more databases based on a similarity of attributes; generating a product relationship graph, wherein the product relationship graph indicates a relationship between the first product data and the at least one or more of the plurality of product data stored in the one or more databases; storing the product relationship graph and the first product data in the one or more databases; receiving a product recommendation request from the user via the graphical user interface, wherein the product recommendation request comprises a criteria selected by the user for a product recommendation; generating, in response to the product recommendation request, the product recommendation by analyzing the plurality of product data stored in the one or more databases and the product relationship graph in accordance to the criteria selected by the user; and managing inventory for a plurality of physical products corresponding to the plurality of product data based on Automated Identification and Data Capture (AIDC), wherein the plurality of product data includes the received first product data, and wherein managing inventory for each of the plurality of physical products further comprising: creating a product instance for a physical product, wherein the physical product is marked with a unique AIDC tag, and wherein the product instance indicates a current location of the physical product, monitoring a location of the physical product marked with the AIDC tag using AIDC scanning capable devices, wherein the AIDC scanning capable devices are associated with inventory locations, tracking the location of the physical product when an AIDC scanning capable device detects the AIDC tag, and automatically updating the current location of the product instance associated with the physical product.

In some embodiments, the computerized method further comprises the step of recording a usage confirmation of the physical product, wherein the usage confirmation is provided by a preauthorized user.

In some embodiments, the computerized method further comprises the step of automatically ordering one or more products based on the product usage confirmation provided by the preauthorized user.

In some embodiments, the predefined classifications are modified and additional classifications are added to the predefined classifications by the user.

In some embodiments, the predefined classifications include one or more of tag(s), product number, text, universal classifiers, order classifiers, and product classifiers.

In some embodiments, the computerized method further comprises the step of receiving a request from the user to view the plurality of product data on the one or more databases; and in response to the request, displaying a list of the plurality of product data to the user through the graphic user interface.

In some embodiments, the computerized method further comprises the step of receiving a request from the user to modify a product data from the list of the plurality of product data; and modifying the product data in the one or more databases.

In some embodiments, creating the product instance for the selected product further comprises scanning an electronic product code for the unique AIDC tag; and inputting the physical product expiration date, lot number, and UDI number.

In some embodiments, the product recommendation request further comprises past purchase data regarding the first products.

In some embodiments, the product recommendation comprises an analysis based on cost efficiency.

In some embodiments, the product recommendation comprises an analysis based on vendor optimization.

In some embodiments, the usage confirmation includes one or more of: quantity of product(s) used, EPC, lot number, UDI number, date submitted, name of submitter, shipping address of submitter, client, client identification, surgeon/physician name, surgery number, procedure, and notes.

In another aspect, a system for product relationship, recommendation, and inventory management is disclosed. The system comprises an application server configured to provide a graphical user interface to a user. The system further comprises a processing server coupled to the application server and comprising one or more processors, the processing server configured to: receive a first product data provided by the user via the graphical user interface, wherein the first product data includes a first list of one or more attributes of a first product, and wherein each attribute is associated with predefined classifications; compare the first list of one or more attributes of the first product with a plurality of lists of one or more attributes for a plurality of product data stored in one or more databases; automatically relate the first product data with at least one or more of the plurality of product data stored in the one or more databases based on a similarity of attributes; generate a product relationship graph, wherein the product relationship graph indicates a relationship between the first product data and the at least one or more of the plurality of product data stored in the one or more databases; store the product relationship graph and the first product data in the one or more databases; receive a product recommendation request from the user via the graphical user interface, wherein the product recommendation request comprises a criteria selected by the user for a product recommendation; generate, in response to the product recommendation request, the product recommendation by analyzing the plurality of product data stored in the one or more databases and the product relationship graph in accordance to the criteria selected by the user; and manage inventory for a plurality of physical products corresponding to the plurality of product data based on Automated Identification and Data Capture (AIDC), wherein the plurality of product data includes the received first product data, and wherein managing inventory for each of the plurality of physical products further comprising: create a product instance for a physical product, wherein the physical product is marked with a unique AIDC tag, and wherein the product instance indicates a current location of the physical product, monitor a location of the physical product marked with the AIDC tag using AIDC scanning capable devices, wherein the AIDC scanning capable devices are associated with inventory locations, track the location of the physical product when an AIDC scanning capable device detects the AIDC tag, and automatically update the current location of the product instance associated with the physical product.

In yet another aspect, a computer program product comprising a non-transitory computer readable medium storing a computer program for product relationship, recommendation, and inventory management is disclosed. The computer program comprises code which run by a processor causes the processor to: provide a graphical user interface to a user; receive a first product data provided by the user via the graphical user interface, wherein the first product data includes a first list of one or more attributes of a first product, and wherein each attribute is associated with predefined classifications; compare the first list of one or more attributes of the first product with a plurality of lists of one or more attributes for a plurality of product data stored in one or more databases; automatically relate the first product data with at least one or more of the plurality of product data stored in the one or more databases based on a similarity of attributes; generate a product relationship graph, wherein the product relationship graph indicates a relationship between the first product data and the at least one or more of the plurality of product data stored in the one or more databases; store the product relationship graph and the first product data in the one or more databases; receive a product recommendation request from the user via the graphical user interface, wherein the product recommendation request comprises a criteria selected by the user for a product recommendation; generate, in response to the product recommendation request, the product recommendation by analyzing the plurality of product data stored in the one or more databases and the product relationship graph in accordance to the criteria selected by the user; and manage inventory for a plurality of physical products corresponding to the plurality of product data based on Automated Identification and Data Capture (AIDC), wherein the plurality of product data includes the received first product data, and wherein managing inventory for each of the plurality of physical products further comprising: create a product instance for a physical product, wherein the physical product is marked with a unique AIDC tag, and wherein the product instance indicates a current location of the physical product, monitor a location of the physical product marked with the AIDC tag using AIDC scanning capable devices, wherein the AIDC scanning capable devices are associated with inventory locations, track the location of the physical product when an AIDC scanning capable device detects the AIDC tag, and automatically update the current location of the product instance associated with the physical product.

Further variations encompassed within the systems, methods, and computer program products are described in the detailed description of the invention below with reference to the accompanying drawings.

### BRIEF DESCRIPTION OF THE DRAWINGS

The accompanying drawings, which are incorporated herein and form part of the specification, illustrate various embodiments.

FIG. 1 illustrates an exemplary architecture of a communication system in accordance with exemplary embodiments of the present invention.

FIG. 2 is a block diagram of a client device in accordance with exemplary embodiments of the present invention.

FIG. 3 is a block diagram of a server device in accordance with exemplary embodiments of the present invention.

FIG. 4 illustrates an exemplary Product Relationship, Recommendation, and Inventory Management system, according to some embodiments.

FIG. 5 illustrates an exemplary flowchart of the Product Relationship, Recommendation, and Inventory Management system, according to some embodiments.

FIG. 6 illustrates an exemplary flow chart of the Team Management Engine of the system, according to some embodiments.

FIG. 7 illustrates an exemplary flow chart of the Upload Products Engine of the system, according to some embodiments.

FIG. 8 illustrates an exemplary flow chart of the Product Database Engine of the system, according to some embodiments.

FIG. 9 illustrates an exemplary flow chart of the Relate Products Engine of the system, according to some embodiments.

FIG. 10 illustrates an exemplary flow chart of the Product Counsel Engine of the system, according to some embodiments.

FIG. 11 illustrates an exemplary flow chart of the Inventory Engine of the system, according to some embodiments.

FIG. 12 illustrates an exemplary flow chart of the Custody Engine of the system, according to some embodiments.

FIG. 13 illustrates an exemplary flow chart of the Usage Confirmations Engine of the system, according to some embodiments.

FIG. 14 is a flow chart of a process for product relationship, recommendation, and inventory management, according to some embodiments.

FIG. 15 is a flow chart of a process for product relationship, recommendation, and inventory management, according to some embodiments.

### DETAILED DESCRIPTION

An object of embodiments described herein is to obviate at least some of the aforementioned problems with conventional methods of healthcare product transaction and management. Systems, devices, and methods described herein provide an integrated solution for streamlined and consistent product data management, guided purchase solution designed to reduce purchase costs, and automated inventory management designed to reduce cost of wasted, lost, and stolen inventory.

As used in the context of this application, “healthcare providers” include but is not limited to hospitals and hospital networks, group purchasing organizations (GPOs) and/or integrated delivery networks (IDNs), payers and ambulatory surgery centers (ASCs).

As used in the context of this application, “Automatic Identification and Data Capture” refers to current and future AIDC technologies including but not limited to radio frequency identification (RFID), bar codes, biometrics, Bluetooth, magnetic stripes, Optical Character Recognition (OCR), smart cards, and voice recognition.

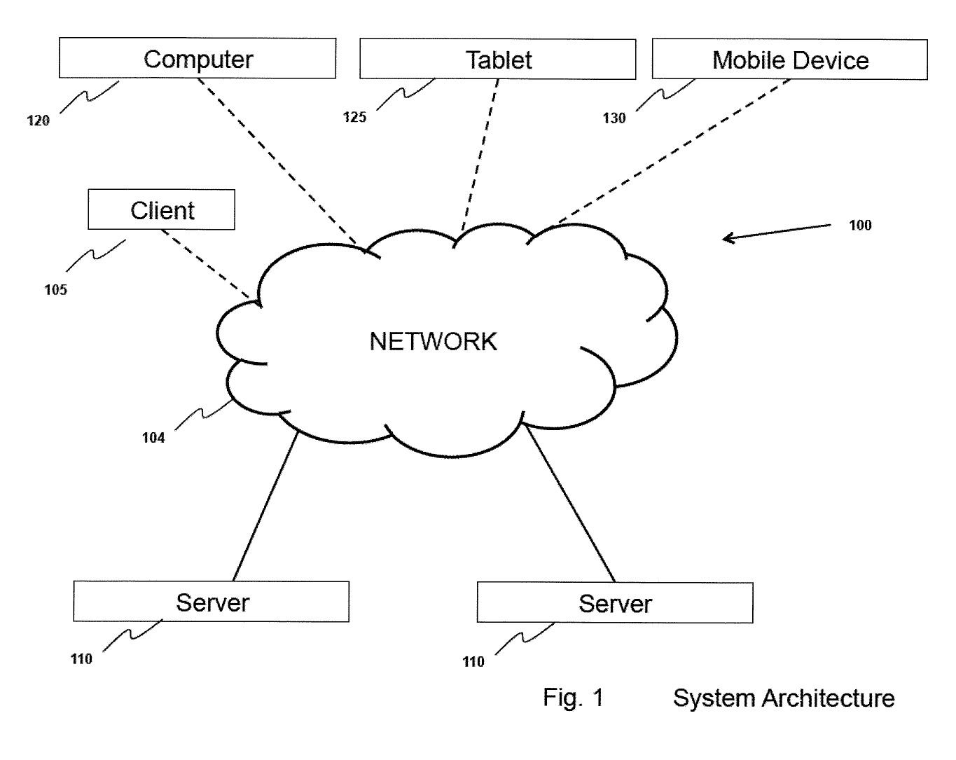

Referring to FIG. 1, an exemplary architecture of a communication system in accordance with exemplary embodiments of the present invention is illustrated. System 100 includes at least one web server 110 that is configured to communicate with one or more client user devices 105 through a communications network 104 (e.g., the Internet). Examples of client user devices include a computer 120, a tablet 125, and a mobile device 130. The systems, methods and computer program products of the present invention can, for example, be deployed as a client-server implementation, as an ASP model, or as a standalone application running on a user device 105.

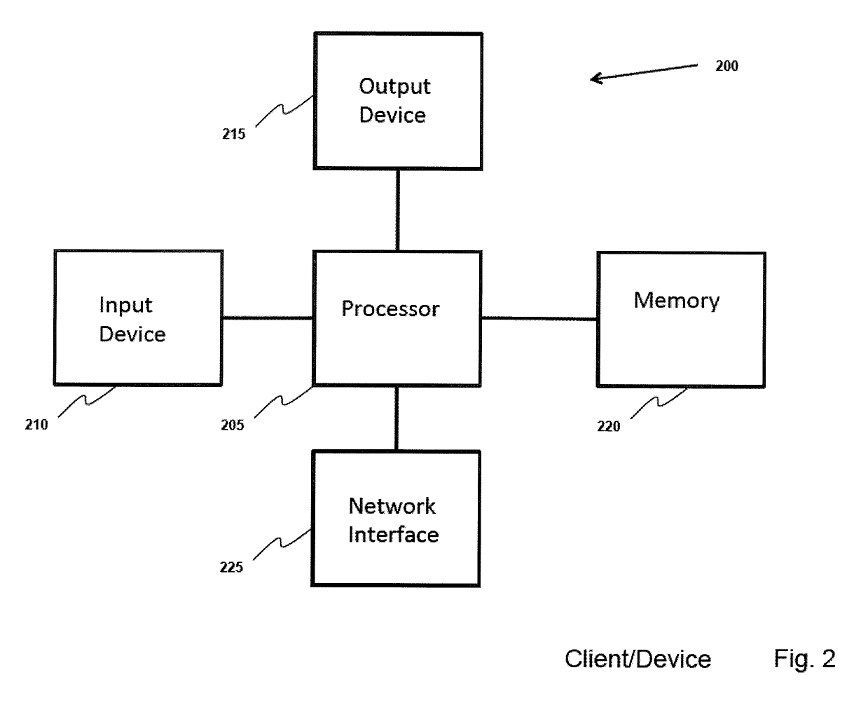

Referring to FIG. 2, a block diagram of a device 200, such as for example, a client user device 105 including but not limited to a computer, a tablet, or a mobile device, in accordance with exemplary embodiments of the present invention, is illustrated. As shown in FIG. 2, the device 200 may include a processor 205, which may include one or more microprocessors and/or one or more circuits, such as an application specific integrated circuit (ASIC), Field-programmable gate arrays (FPGAs), etc.

The device 200 may include a network interface 225. The network interface 225 is configured to enable communication with a communication network, using a wired and/or wireless connection.

The device 200 may include memory 220, which may include one or more non-volatile storage devices and/or one or more volatile storage devices (e.g., random access memory (RAM)). In instances where the device 200 includes a microprocessor, computer readable program code may be stored in a computer readable medium, such as, but not limited to magnetic media (e.g., a hard disk), optical media (e.g., a DVD), memory devices (e.g., random access memory), etc. In some embodiments, computer readable program code is configured such that when executed by a processor, the code causes the device to perform the steps described below. In other embodiments, the device is configured to perform steps described below without the need for code.

The device 200 may include an input device 210. The input device is configured to receive an input from either a user or a hardware or software component. Examples of an input device 210 include a keyboard, mouse, microphone, touch screen and software enabling interaction with a touch screen, etc. The device may also include an output device 215. Examples of output devices 215 include monitors, televisions, mobile device screens, tablet screens, speakers, etc. The output device 215 can be configured to display images or video or play audio to a user. One or more of the input and output devices can be combined into a single device.

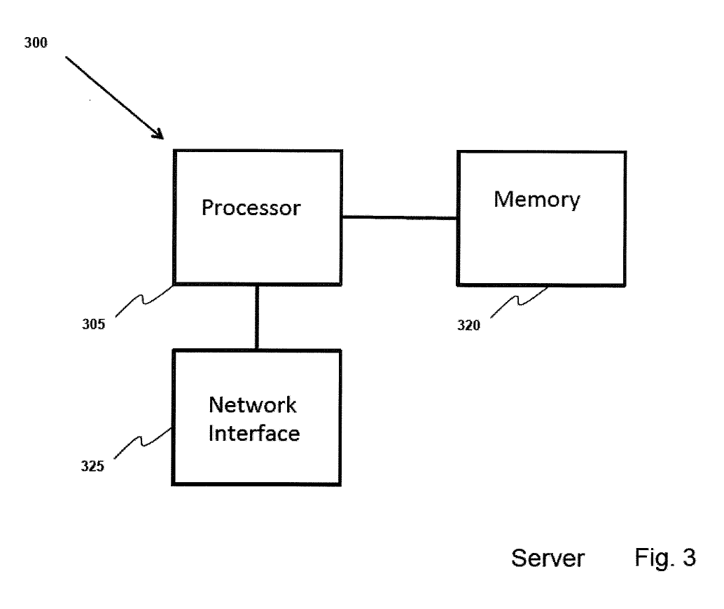

Referring now to FIG. 3, a block diagram of a server in accordance with exemplary embodiments of the present invention is illustrated. As shown in FIG. 3, the server 300 may include a network interface 315 for transmitting and receiving data, a processor 305 for controlling operation of the server device 300, and a memory 310 for storing computer readable instructions (i.e., software) and data. The network interface 315 and memory 310 are coupled to and communicate with the processor 305, which controls their operation and the flow of data between them.

Processor 305 may include one or more microprocessors and/or one or more circuits, such as an application specific integrated circuit (ASIC), Field-programmable gate arrays (FPGAs), etc. Network interface 325 can be configured to enable communication with a communication network, using a wired and/or wireless connection. Memory 310 may include one or more non-volatile storage devices and/or one or more volatile storage devices (e.g., random access memory (RAM)). In instances where server system 300 includes a microprocessor, computer readable program code may be stored in a computer readable medium, such as, but not limited to magnetic media (e.g., a hard disk), optical media (e.g., a DVD), memory devices (e.g., random access memory), etc. In some embodiments, computer readable program code is configured such that when executed by a processor, the code causes the device to perform the steps described below. In other embodiments, the device is configured to perform steps described below without the need for code. In some embodiments, the term “server” is used interchangeably with “engine” and/or “management system.”

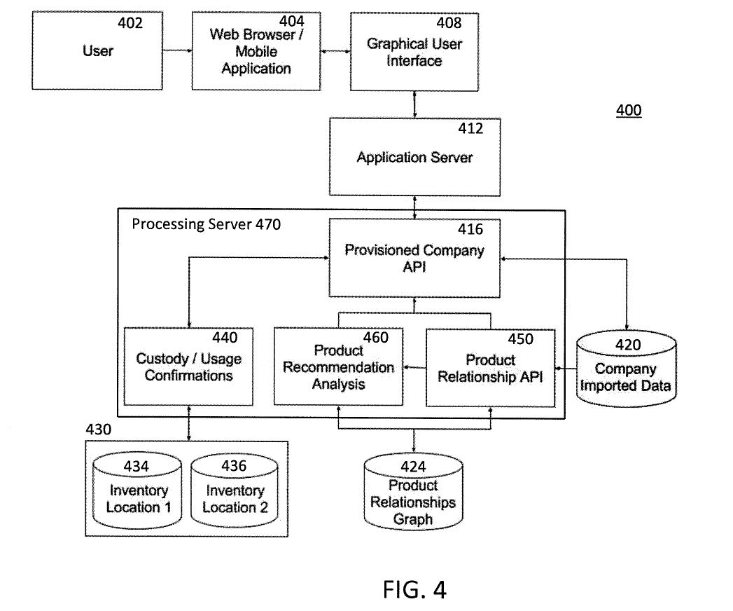

Referring now to FIG. 4, an exemplary Product Relationship, Recommendation, and Inventory Management system, according to some embodiments, is illustrated. FIG. 4 depicts an overall flow diagram of the system with technical components necessary for a User 402 that enables interaction with the application and the intelligent systems involved. As shown in FIG. 4, the individual components represented by boxes are connected by arrows and placed in order to depict a sequence of events simulating the process of the Product Relationship, Recommendation, and Inventory Management System (“PRRIMS”) 400, according to some embodiments. The individual components of the PRRIMS 400 comprises a Graphical User Interface 408 served by an Application Server 412, a Provisioned Company Application Programmable Interface (API) 416, a Company Imported Data Database 420, a Product Relationships Database 424, at least one Inventory Location Database 434-436 in a company's AIDC tracked data cluster database 430, a Custody and Usage Confirmation system 440, a Product Relationship API 450, and a Product Recommendation Analysis Engine 460. In an exemplary embodiment, a processing server 470 comprises the Provisioned Company API 416, the Custody and Usage Confirmation system 440, the Product Relationship API 450, and the Product Recommendation Analysis Engine. A participating User 402 may use a Web Browser/Mobile Application 404 to access the PRRIMS 400.

In an exemplary embodiment, a web-based application system that incorporates the functionality of the PRRIMS 400 is provided to the User 402 in the form of a Graphical User Interface 408 and accessed through the Web Browser/Mobile Application 404 by requesting the specific web address. Using the Graphical User Interface 408, the User 400 is then prompted to upload a company's product data to the PRRIMS 400. The Application Server 412 will transmit the product data provided by the user to the Provisioned Company API 416 as an information payload. The Provisioned Company API 416 receives, processes, and stores data uploaded the company in isolated databases within the Company Imported Data Database 420. In an embodiment, logically isolated sections of the network may be provided for each Company's uploaded data into separate individual databases within the Company Imported Data Database 420 to ensure data integrity and security. In an embodiment, the data transmission between the Application Server 412 and the Provisioned Company API 416 may include Company identification and hashed session keys within the header to establish trusted communication for proper handshaking. On each successful product upload, the Graphical User Interface 408 will then give the ability to the User 402 to properly match recipient fields of the product data with predefined classifiers or labels populated in an option menu. A label is assigned to each upload to identify the upload type depending on its request method. For example, the upload type, i.e. the request method, may be through a file reader, API parsing or manual input. In an embodiment the matching data, the upload type and the body of the product data will make up the structure of the main content in the payload.

In some embodiments, once the Provisioned Company API 416 receives the request from the Application Server 412, the PRRIMS 400 sends the product data and the matching data defined by the User 402 to its appropriate set of data parsing procedures according to the corresponding upload type. While a copy of purely unprocessed product data gets immediately stored in the Company Imported Data Database 420, another set of the same data gets compared between its relatable qualities to product data that has previously been stored in the Product Relationships Database 424. This comparison process takes the fields that were matched by the User 402 during product upload and maps to the field of the same type across all previously uploaded product data thus building an indexed network system for fast executing queries later used throughout the system. Each row in the product data gets the same treatment and ultimately producing a widespread product relationship graph of interconnecting products by similar fields. This network graph, once fully processed, is then stored in the Product Relationships Graph 424 database.

In some embodiments, the Product Relationship API 450 is a minimal application server that has exclusive data access to the Product Relationships Graph 424 database acting to dispatch incoming data read requests and outgoing data responses to the Provisioned Company API 416. While the Application Server 412 in this scenario is responsible for populating the product relationship data in the HTML (Hypertext Markup Language) on the Graphical User Interface 408, the Provisioned Company API 416 is responsible for packaging the unformatted product relationship data into the appropriate format that the Graphical User Interface 408 can properly distinguish.

In some embodiments, the User 402 is provided a form through the Graphical User Interface 408 and a combination of the interactive user interface tools to set conditions on each field of any given product as parameters in a search query to specify desired data responses. These field conditions set on the form are collected and carried into a transmittable data structure like JSON (Javascript Object Notation) or XML (Extensible Markup Language) and transmitted as a data payload through some form of RPC (Remote Procedure Call) on a protected network port in the isolated Company network environment to the Product Relationship API 450. As the payload reaches the Product Relationship API 450 the field conditions set by the User 402 are each taken and combined to build a query statement to submit against the Product Relationship Graph 424 database until a narrowed set of product results are retrieved. The results of the database from this retrieval operation is sent through the Provisioned Company API 416 and to the Application Server 412 to format and properly display the desired results of related products according to the set conditions on the Graphical User Interface 408.

In some embodiments, each query statement with an original set of field conditions against a product is then stored in a separate collection of the Product Relationship Graph 424 while simultaneously storing the index of matched product identification of the results to allow more performant retrievals for later use.

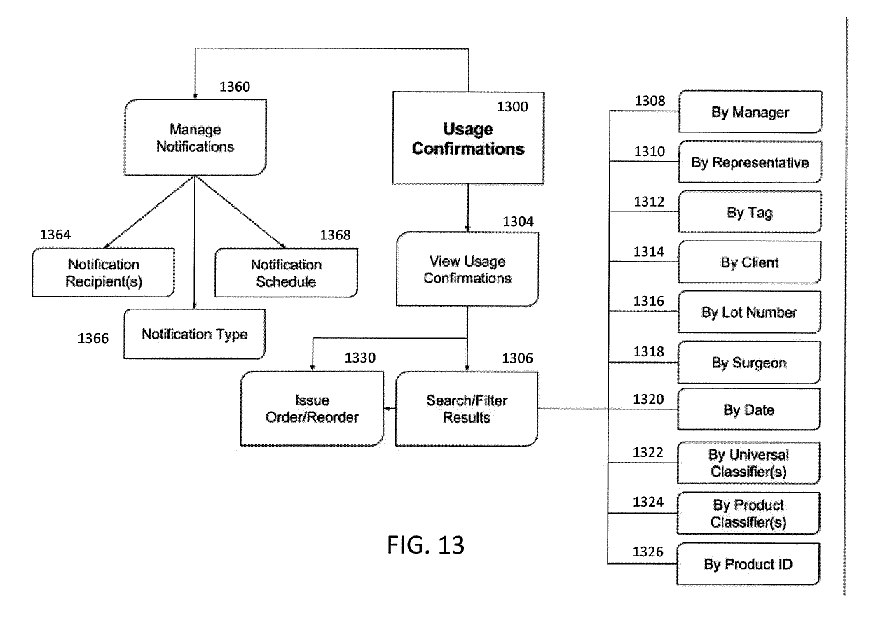

In some embodiments, AIDC (Automated Identification and Data Capture) tracked data cluster database 430 contains a cluster of databases in at least one Inventory Location Database 434-436. Products that are properly marked with an AIDC tag or sticker can be logically monitored through AIDC-scanning capable hardware such as cabinets, vaults, portable totes or AIDC-scanning installations within a room, warehouse, stocking or distribution facilities that are networked to the cloud and accessible via internet via APIs or other data transfer means to establish and maintain communication with the PRRIMS 400. Accordingly, a current location of the product marked with an AIDC tag or sticker can be digitally tracked by the User 402 from a remote location using the Web Browser/Mobile Application 404 and any type of Graphical User Interface 408. In an embodiment, the tracking functionality comes with a standard communication protocol similar to an API that allows the Application Server 412 to accurately represent the material goods available in the AIDC-scanning capable hardware as digital information presented on the Graphical User Interface 408. In addition to inventory reading via the Graphical User Interface 408, a set of API operations are available to the Provisioned Company API 416 to update and delete products with AIDC tags. User specific actions that interact with these backend API operations are explained in further detail in the following description with reference to FIG. 13. Physical changes made to products tracked with AIDC are translated to a standard protocol definition easily readable and accessible so that the Provisioned Company API 416 can react in real time and perform further operations accordingly.

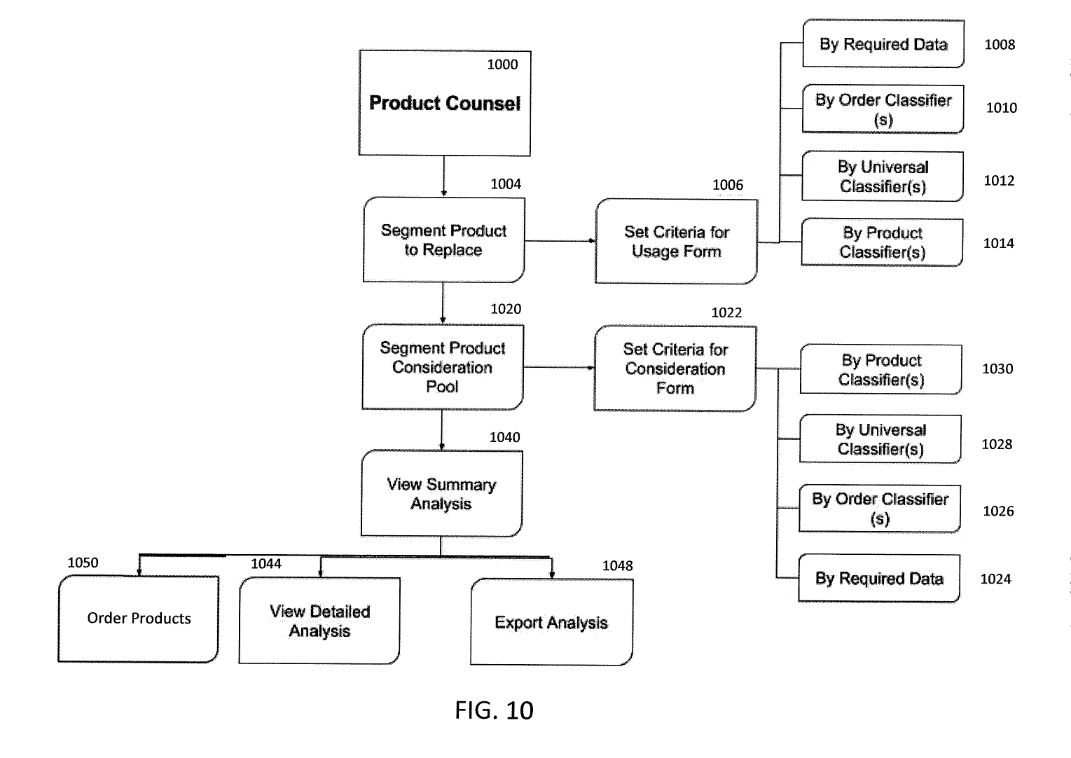

In some embodiments, data from the Product Relationships Graph 424 combined with data from the Company Imported Data Database 420 feeds the Product Recommendation Analysis Engine 460 giving the User 402 the ability to discover opportunities both to save costs and to optimize vendors. The User's 402 interactions with the Product Recommendation Analysis Engine 460 are explained in further detail in the description regarding FIG. 10.

The technical specifications for the Product Recommendation Analysis Engine 460, in some embodiments, are as follows. When prompted, the Graphical User Interface 408 will serve two multi selection forms to the User 402, described here as a Usage and Consideration form, thereby allowing the User 402 to set criteria against several filtering options that help narrow results returned from this query sent to the Product Recommendation Analysis Engine 460. Each value selected in the first form, the Usage form, is collected and served as parameters passed into the general function of the Product Recommendation Analysis Engine 460. The set of values specified in the Usage form instruct the system to select matching records from the Company Imported Data Database 420 and establish a partition of products as a working dataset for any user interactions and instructions that follow within the same session. A session is defined as the cycle from which the Usage form is initially submitted until either the application closes or any subsequent submission on the Usage form are made.

The query is built with the specified values in a JSON payload and sent to the Product Recommendation Analysis Engine 460 for values to be mapped in an aggregate structure to then be executed through the mass collection of product relationships in the Product Relationships Graph 424. Depending on the form option picked by the User 402 the result for the aggregate price property will either be the highest number found in the price field in the aggregated products, the lowest number found, the number from the most recent product in date, the average number or the mean number across all records in the aggregated products. After the Product Recommendation Analysis Engine 460 executes the query, aggregation, and calculation, the final outcome will include the aggregate price, helper meta-data and the product records grouped by the three classifier types: Universal, Order and Product. The results from this query are isolated from the original database and stored temporarily in a virtual database to be queried against or visually previewed throughout the rest of the same session. Any subsequent change made in Usage form will automatically trigger new queries and apply updates to the isolated results carried in the virtual database. The Product Recommendation Analysis Engine 460 constantly listens for broadcasting changes made from the Usage form.

In some embodiments, when the desired products are successfully isolated, the User 402 then proceeds to the second form, the Consideration form, in order to consider products for recommendation. Much like the procedures taken for the Usage form, the values selected in the Consideration form will get passed into a JSON payload and transmitted through the Application Server 412 and the Provisioned Company API 416 to finally arrive in the Product Recommendation Analysis Engine 460 where each field gets processed in the search query against the Product Relationships Graph 424. Each record in the results from this query contains a price field. The aggregation of this field gets compared against the User 402 set criteria in the field “If Multiple Prices” to determine the value for the property for the final aggregate price much like the example explained in the Usage form. A data response is composed with the value of this property, the product records from the query grouped by product types, and helper meta-data to be transmitted back to the original sender for storage in the same virtual database that carries product data first isolated in the Usage form.

Once both datasets prepared by the previous steps in the session are available in the temporary virtual database, the Product Recommendation Analysis Engine 460 then begins calculating the numbers under the price field for both datasets. The difference is then calculated between the two sums of the price fields in each dataset. The Graphical User Interface 408 will present this final number as the “Greatest Savings” using the criteria given by the User 402.

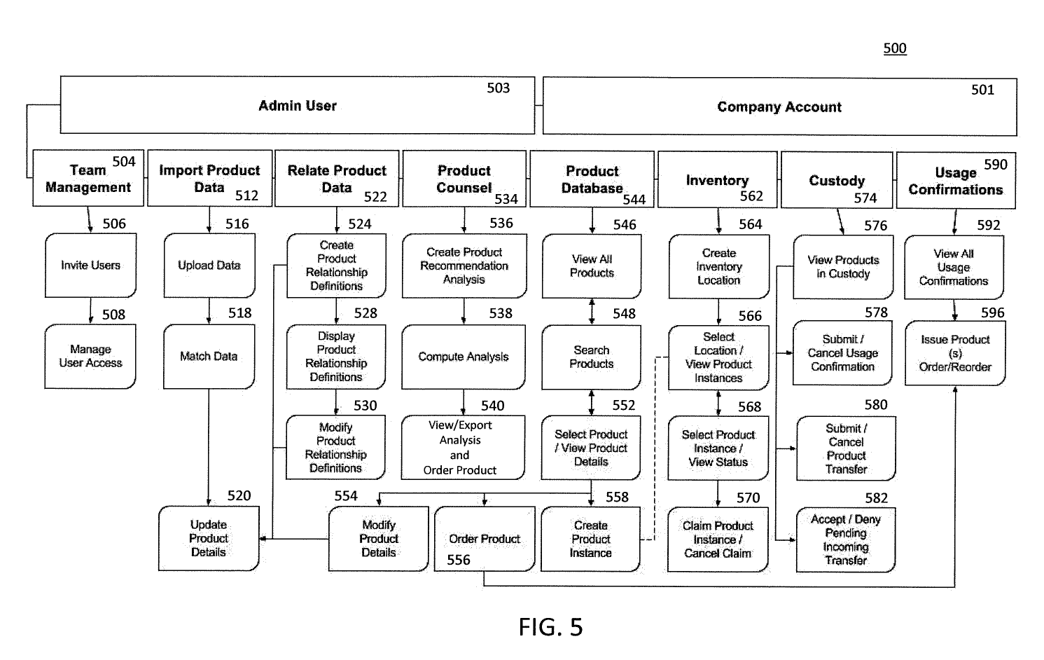

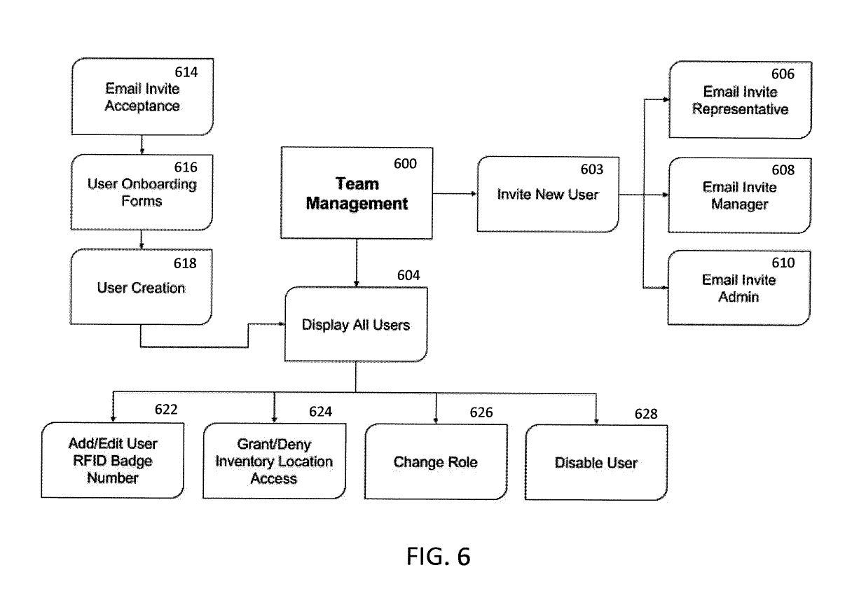

FIG. 5 illustrates an exemplary flowchart of the Product Relationship, Recommendation, and Inventory Management System in more detail, according to some embodiments. Starting with the creation of Company Account 501 and Admin User 503, the Product Relationship, Recommendation, and Inventory Management System (“PRRIMS”) 500 includes a Team Management Engine 504, including the ability to Invite Users 506 through email, among other methods of inviting Users, and Manage Users' Access 508 to additional features throughout the entirety of the application through role assignment. The Team Management Engine 504 is explained in further detail in the following description with reference to FIG. 6.

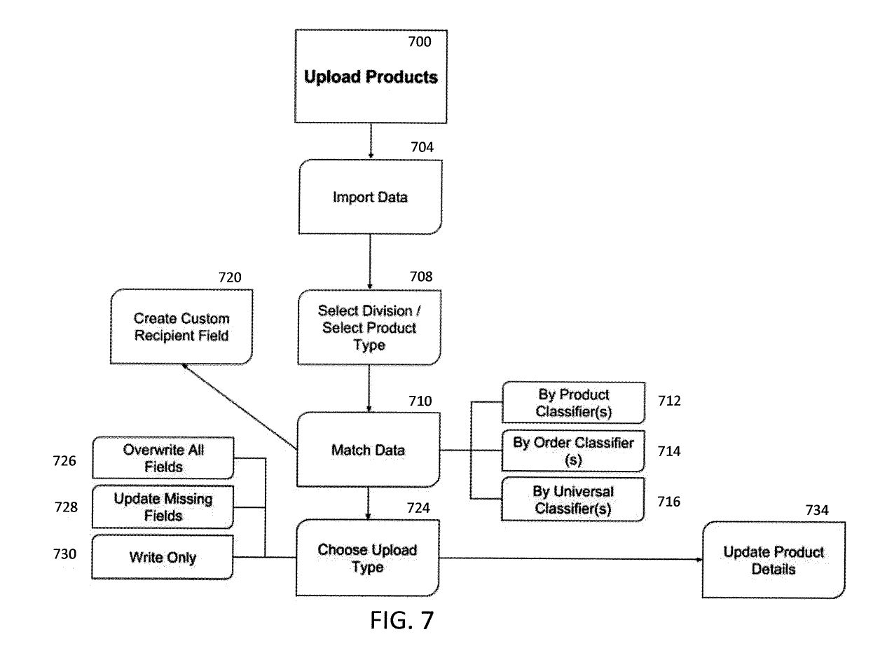

In some embodiments, the first feature of the PRRIMS 500 provided by the Import Product Data Engine 512 which enables the importing product data into the PRRIMS 500 through file uploads, API integration, or manual input. The Import Product Data Engine 512 prompts an Admin user 503 or any invited user, using the Graphical User Interface, to upload a company's product data (step 516—Upload Data), then immediately match the uploaded product data with inputs to their respective fields within the available offering (step 518—Match Data). Should an appropriate recipient field not exist, the Admin User 503 may create a custom recipient field to which an Admin User 503 may match the uploaded data. Upon successful completion of the Import Product Data Engine 512 steps (steps 516-518), a Company Account 501 will have uploaded product data stored within a Product Database 544 and product details corresponding to the products stored in the Product Database 544 will be updated (step 520—Update Product Details). The Import Product Data Engine 512 is further explained in the following description regarding FIG. 7.

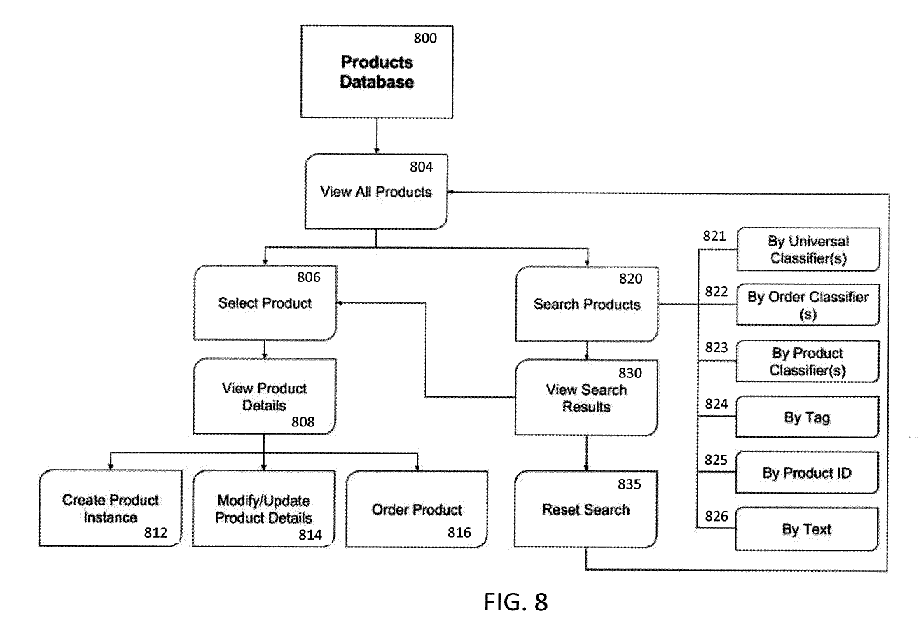

In some embodiments, the Product Database 544 provides the available product data for a Relate Product Data Engine 522 and subsequently a Product Counsel Engine 534. The Product Database 544 further populates the available products to be discovered and used in the Inventory Engine 562 and subsequently the Custody Engine 574 and subsequently the Usage Confirmations Engine 590. Within the Product Database Engine 544, the Admin User 503 or any invited user may view all products stored in the Product Database 544 (step 546—View All Products) and either select a product and view product details for the selected product (Step 552—Select Product/View Product Details) or conduct a search for a specific product in the Product Database 544 (step 548—Search Products) then select the product and the product details (step 522—Select Product/View Product Details). When viewing product details (step 552—View Product Details), the Admin User 503 or any invited user may choose any combination of the following actions: Modify Product Details (step 554), Order Product (step 556), or Create a Product Instance (step 558). Modifying Product Details (step 554) will update the affected product with any changes to its data. Ordering Product (step 556) will send an order request to a specified user. Creating a Product Instance 558 will enable the Admin User 503 or any invited user to add a unique product's Lot Number, Universal Device Identification (UDI) number, and Expiration Date as well as a corresponding Automated Identification and Data Capture (AIDC) tag's Electronic Product Code (EPC) to create a single instance of the product that can be tracked in the Inventory Engine 562, Custody Engine 574, and Usage Confirmations Engine 590. An unlimited number of Create Product Instance 558 actions may be taken. The Product Database Engine 544 is further explained in the following description regarding FIG. 8.

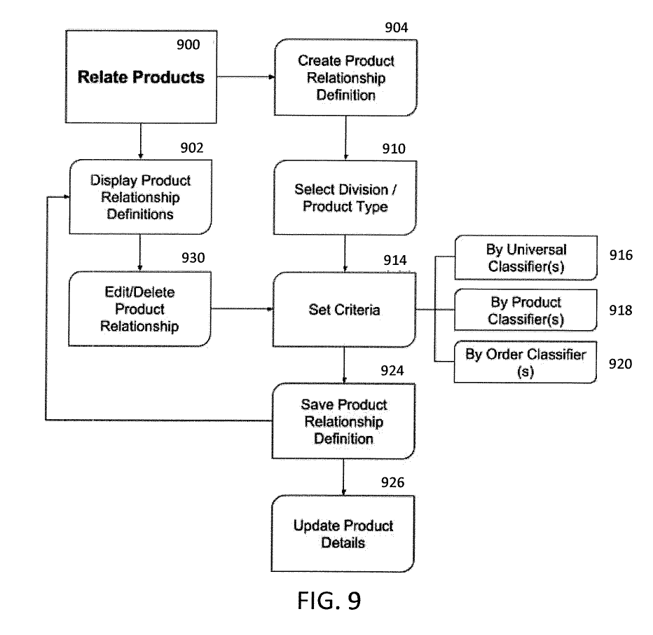

In some embodiments, the Relate Product Data Engine 522 provides the Admin User 503 the ability to create definitions by Product Type to relate products. Using a range of criteria upon uploaded data, a user may create at least one product relationship definition (step 524—Create Product Relationship Definition) per Product Type uploaded. Upon successful creation of a product relationship definition (step 528—Display Product Relationship Definitions) and affected products with product data already stored within the Product Database 544 will have their product details updated (step 520—Update Product Details) with any changes. Product relationship definitions may be modified (step 530—Modify Product Relationship Definitions) at any time and doing so will again update any affected products in product details (step 520). The Relate Product Data Engine 522 is further explained in the following description regarding FIG. 9.

In some embodiments, the Product Counsel Engine 534 conducts computational analysis of related products, usage, and price to offer product recommendations based on the Admin User 503 or any invited user's preferences. The Product Counsel Engine 534 is only available for Product Types for which at least one Product Relationship Definition exists and is active, or being displayed in step 528. Once the analysis has been computed (step 538), Admin User 503 or any invited user may explore the data more in-depth via the application and order one or more products based on the analysis (step 540—View/Export Analysis and Order Product). The User 503 may also export the results of the analysis (step 540—View/Export Analysis and Order Product). The Product Counsel Engine 534 is further explained in the following description with reference to FIG. 10.

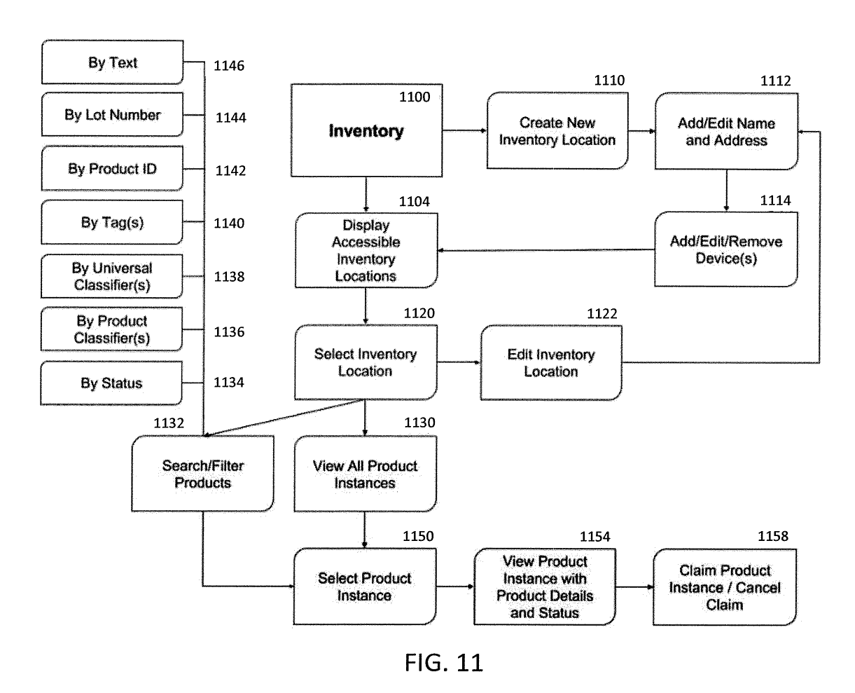

In some embodiments, the Inventory Engine 562 provides the Admin User 503 or any invited user with the ability to select a product from at least one inventory location (step 566—Select Location/View Product Instances) or create an inventory location (step 564—Create Inventory Location). Product Instances created in step 558 are displayed in an Inventory Location 566 when an AIDC-scanning capable device is linked to an Inventory Location and the physical product associated with the virtual Product Instance is detected by the AIDC-scanning capable device. A unique Product Instance is able to be selected in step 568, whereupon the system will display a number of relevant data related to this Product Instance including: all product details data, EPC, Lot Number, UDI Number, Expiration Date as well as a host of Status indicators that notify the user if this Product Instance: a) has been recently added b) is expiring soon c) is expired already or d) is missing. Furthermore, a Product Instance currently found in an Inventory Location is able to be Claimed in step 570 by one user at a given time. Claimed Products expire after a set period of time, may be canceled at any time prior to Claim Expiration and are displayed by the Custody Engine 574 by the View Products in Custody step 576. The Inventory Engine 562 is further explained in the following description regarding FIG. 11.

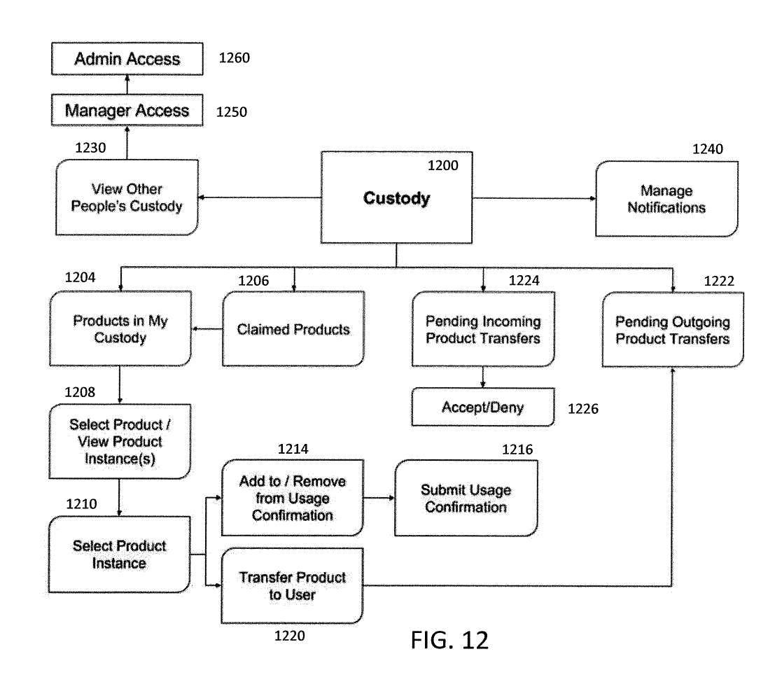

In some embodiments Custody Engine 574 provides the Admin User 503 or any invited user with the ability to view any Product Instances (and their physical counterpart) that are removed from an Inventory Location by the Admin User 503 or any invited user View Products in Custody (step 576) unless one of three actions occur: (1) the user begins to submit a usage confirmation confirming use of the product and completes the action (step 578—Submit/Cancel Usage Confirmation), (2) the user begins a Product Transfer (step 580) to another invited user and the transferee rejects the transfer, and (3) the user returns the Product Instance (and its physical counterpart) to an Inventory Location accessible and displayed in Select Location/View Product Instances (step 566). Additionally, Product Instances may be entered, i.e. may be displayed, in a user's Products in Custody (step 576) if one of three actions occur: (1) the user accepts a Product Transfer from another invited user (step 580—Accept/Deny Pending Incoming Transfer), (2) the user begins but cancels a Usage Confirmation (step 578—Submit/Cancel Usage Confirmation), and (3) the user's Product Transfer request to another invited user is rejected (step 580—Accept/Deny Pending Incoming Transfer). The Custody Engine 574 is further explained in the following description regarding FIG. 12.

In some embodiments, Usage Confirmations Engine 590 successfully submitted Usage Confirmations from step 578 by the Admin User 503 and all invited users are stored and displayed chronologically in View All Usage Confirmations (step 592). Multiple filters are available to search, filter and segment the Usage Confirmations. A submitted Usage Confirmation displayed in View All Usage Confirmations (step 592) includes, but is not limited to, the following information: Product Details for each product included and quantity of product(s) used, EPC, Lot Number, UDI Number, Date Submitted, Name of Submitter, Shipping Address of Submitter, Client, Client ID, Surgeon/Physician Name, Surgery Number, Procedure, and Notes. In an embodiment, the PRRIMS 500 may include the ability to create custom reporting based on the available data listed above. The Admin User 503 has the added ability to issue orders and/or reorders of products (step 596), to add an additional user to fulfill this role, and to set notification types and schedules for submitted Usage Confirmations. The Usage Confirmations Engine 590 is further explained in the following description with reference to FIG. 13.

FIG. 6 illustrates an exemplary flow chart of the Team Management Engine function of the system, according to some embodiments. The Team Management Engine 600 allows an Admin User to add team members (step 603) to the account by role via email (steps 606-610). When an invitee receives an invite email and clicks the unique link contained within the email (step 614), he/she is taken through a series of onboarding steps to collect user-specific information, such as First Name, Last Name, Phone Number, Shipping Address, Territory/Manager 616. Upon successful completion of onboarding forms, an account is created for the user (step 618).

In an embodiment, when a user account is created, the user's information is displayed for the Admin user to manage (step 604). The Admin user may add an AIDC Badge Identification to the user for physical access to Inventory Locations and for Custody tracking and this AIDC Badge Identification may be edited at any time (step 622). The Admin user may Grant or Revoke access to Inventory Locations, limiting the amount of information accessible to the user (step 624).

In an embodiment, at least three roles of users exist in the Product Relationship, Recommendation, and Inventory Management System, each with varying levels of access and visibility throughout the application: Admin, Manager, and Representative. Members with the role of Admin have full access and visibility through the application and are able to upload product data, modify product data, create and modify product relationship definitions, create and modify inventory locations, view all submitted usage confirmations and manage team member access whereas Managers and Representatives do not possess these abilities.

In an exemplary embodiment, an Admin may change the user's role at any given time (step 626). For example, the Admin may change the role of a user from a Representative to a Manager and even to an Admin role. In another embodiment, the Admin may also disable a user's account, revoking access to the entire system (step 628).

FIG. 7 illustrates an exemplary flow chart of the Upload Products Engine of the system, according to some embodiments. The importation of data (step 704) to the system is an Admin level functionality. Data may be imported via file uploads, via an API, or via manual addition. Once data has been successfully imported, the system prompts the user to provide the Division and Product Type to which the uploaded data corresponds (step 708). For example, a division of a particular product may be “vascular” and a product type may be “peripheral stents.” Once the Division and Product Type have been specified, the Admin user matches the imported data with its recipient fields provided by the system. An example of this matching process is to apply company names within a dataset to the Company Name recipient field (step 710).

In an exemplary embodiment, provided recipient fields are organized into three classifications: Product Classifiers 712, Order Classifiers 714, and Universal Classifiers 716. Product Classifiers 712 refer to a set of customizable recipient data fields that include, but are not limited to, Product Number, Length, Width, Height, Material, Weight, Design, Shape, MRI Compatibility, Holes, Diameter, Surface Features, Sterile Packaging, Lordosis, Volume, Degree, Thread, Approach, Electrode Combinations, Connector Type, Chambers, Lead Type, Lead Tip Area, Polarity, Longevity and any additional attributes that may be considered product-related. Order Classifiers 714 refer to a set of customizable recipient data fields that include, but are not limited to, Purchase Document, Purchase Document Item Number, Order Date, Price ($), Order Quantity, Unit Measurement, Purchase Location and other order-specific data.

Universal Classifiers 716 refer to a set of customizable recipient data fields that include, but are not limited to, Company ID, Company, Division, Product Type, Product Number, Product Packaging Number, Product Description, System Name, Procedure(s), ICD 10 Code(s), CPT Code(s), FDA Information, Product Image(s), Product Webpage, Product PDF, Product Video, Internal Product Category, Related Products, Free Shipping, On Contract, Tags, Diagnosis-Related Group (DRG), and other universal product data.

In an exemplary embodiment, if a desired recipient data field does not exist, the Admin may create a Custom Recipient Data Field (step 720) to match the imported data. To create a Custom Recipient Data Field, and upon selection of this option, the Admin must provide a name for this new recipient field and determine its type—a string, a number, a price or a date field—then select a Classifier type—Universal, Order, or Product, to store the newly created field. Once created, the Admin may now match imported data to this new Custom Recipient Data Field.

In an exemplary embodiment, after the Admin has successfully matched the imported data to recipient fields, the next step is the selection of the type of upload (step 724). In an embodiment, the Admin may Overwrite All Existing Fields, replacing all existing data in the Product Database with the newly imported data (step 726). In another embodiment, the Admin may Update Missing Fields, filling in Product Details currently missing with the newly imported data (step 728). In another embodiment, the Admin may Write Only (step 730). Once the Upload Type has been specified, the Admin may select Import Data (step 704), upon which all affected Product Details will be updated with the newly imported data (step 734).

FIG. 8 illustrates an exemplary flow chart of the Product Database Engine of the system, according to some embodiments. The Product Database 800 is where majority of the product data exploration takes place. All user roles are able to view all Products that have been imported into the company account and stored in the product database (step 804).

In an exemplary embodiment, all user roles are able to scroll to find a product to select or utilize the search and filter options to limit the number of product results displayed to the user (step 820). The Product Database may be searched or filtered by any combination of Universal Classifiers (as described in FIG. 7) 821, Order Classifiers (as described in FIG. 7) 822, Product Classifiers (as described in FIG. 7) 823, Tag(s) 824, Product Number 825, or Text 826. As a user begins to search and/or filter the Product Database, real-time search results are displayed to the user (step 830). The search may be reset at any time (step 835), returning a user to the View All Products step (step 804).

In an exemplary embodiment, if the user selects a Product from the Product Database (step 806), the Product Details page of the chosen Product is displayed (step 808). The Product Details page displays all imported data for the chosen product, the same data known as Universal, Order, and Product data. Admin users have the option to modify the product details and any changes made to any of the product data will be persistent until additional modification (step 814). All users have the ability to Order the currently displayed product, in which the system will deliver the Order Request to Admins (or an Admin delegated recipient) (step 816). The Order Request requires a quantity and shipping location to be successfully processed. All users furthermore have the ability to create a product instance (step 812) for the currently displayed product, in which the user may apply a unique AIDC tag directly to the physical product packaging, scan or manually input the AIDC tag Electronic Product Code (EPC), input the physical product's Expiration Date and input the physical product's Lot Number and UDI Number. Once all the required information has been entered, the user may select Create to create the Product Instance (step 812). Product Instances are unique instances of a specific product that enable the system to track the product with AIDC-scanning hardware as the product travels between Inventory Locations as well as between User Custody.

FIG. 9 illustrates an exemplary flow chart of the Relate Products Engine 900 of the system, according to some embodiments. All current created and active Product Relationship Definitions will be displayed upon selecting the Relate Products navigation link (step 902). If no such Product Relationship Definitions currently exist, an Admin user will be prompted to Create a New Product Relationship Definition (step 904).

In an exemplary embodiment, when creating a Product Relationship Definition, the first step an Admin user will take is to select the Division and Product Type for which he or she wishes to construct the criteria to relate products (step 910). Once selected, the Admin user will then be presented with the criteria with which to relate products. Criteria to relate products includes Universal Classifiers (as described in FIG. 7), Order Classifiers (as described in FIG. 7), and Product Classifiers (as described in FIG. 7)(step 914). Each data point within a classifier collection will have the following options to modify to begin to create product relationships and be presented to the Admin user for modification (step 914).

In an exemplary embodiment, if the data point (or “Classifier”) is a string, the Admin user is offered the ability to match either “EXACT MATCH”, in which the string between two products must be identical, or “ANY”, which behaves as an Ignore function.

In an exemplary embodiment, if the data point (or “Classifier”) is a number or price or date, the Admin is offered the ability to set a range “WITHIN X”, where “X” refers to a number, or “ANY”, which behaves as an Ignore function.

In an exemplary embodiment, the default setting for each data point within a classifier is set to “ANY” until modified by the Admin user. Admin users that change “ANY” on a particular classifier that is a string to “EXACT MATCH” require no additional modifications for that particular classifier.

In an exemplary embodiment, Admin user that changes “ANY” on a particular classifier that is a number, price or date to “WITHIN X”, must then further provide a value for “X” by subsequently inputting the desired digit into the provided text field.

In an exemplary embodiment, once all desired Classifiers have been modified, the criteria is now set (step 914) and the user may select Save Product Relationship Definition (step 924). Upon selection, the Saved Product Definition is displayed with all other current and active Product Relationship Definitions in (step 902) and all affected Product Details will be updated with Related Products (step 926). In an embodiment, summary information on the Product Relationship Definition may also be displayed, including, but not limited to: the number of unique products related to at least one other product, the number of unique systems related to at least one other system and the date of last modification of the definition.

In an exemplary embodiment, any Product Relationship Definition may be subsequently edited or modified by the Admin by selecting Edit, returning the Admin user to the criteria modification screen 914 for the Product Relationship Definition to be edited or modified (step 930). Any Product Relationship Definition may also be Deleted at any time by selecting Delete and confirming the selection (step 930).

FIG. 10 illustrates an exemplary flow chart of the Product Counsel Engine of the system, according to some embodiments. The Product Counsel Engine 1000 is a product recommendation engine that evaluates usage of a set of user-defined products within the Product Database and analyzes the Related Products (and their metadata) of the defined set of products to offer Product, System, and Company recommendations to the user.

In an exemplary embodiment, Usage is defined as the price(s) and quantities of purchase for a particular product or collection of products from specified Purchase Locations over a specified period of time.

In an exemplary embodiment, Related Products are defined by the criteria currently active in the Relate Products feature described in FIG. 9 and are saved as metadata on the Product Details of a Product.

In an exemplary embodiment, at least three types of recommendations are offered to the user by the Product Counsel Engine 1000: Greatest Savings, Vendor Optimization, and Custom Product Counsel.

In an exemplary embodiment, as a first step for the Product Counsel Engine 1000, a user must segment an initial set of products which are considered as potentially replaceable products, through the Usage Form (step 1004). In step 1006, a selection of options are presented to the user to set the criteria to segment the initial set of products to analyze and they include, but are not limited to: Required Data 1008, Order Classifiers (as described in FIG. 7) 1010, Universal Classifiers (as described in FIG. 7) 1012, and Product Classifiers (as described in FIG. 7) 1014. The Required Data 1008 a user must include at a minimum to conduct the analysis includes, but is not limited to: Division, Product Type, Purchase Location(s), and If Multiple Prices and Purchase Dates. In an embodiment, the “If Multiple Prices” option within the Required Data 1008 provides the user a mechanism to set a single Price for a single Product within the set of analyzed products. A User may select one of the following responses for “If Multiple Prices”: Highest Price, Lowest Price, Most Recent Price, Average Price, List Price or Mean Price. The remainder of the available segmentation criteria is customizable to the user's desire. In an embodiment, a preview of the number of products within the current segment according to the above criteria modifications may be presented to the user.

In an exemplary embodiment, the second step a user must complete is to segment a set of products to serve as the products that may be included in the Product Counsel's recommendations (step 1020—Segment Product Consideration Pool), the Consideration Form. In step 1022, a selection of options are presented to the user to set the criteria to segment the initial products to analyze and they include, but are not limited to: Required Data 1024, Order Classifiers (as described in FIG. 7) 1026, Universal Classifiers (as described in FIG. 7) 1028, and Product Classifiers (as described in FIG. 7) 1030. The Required Data 1024 comprises data that a user must include at a minimum to conduct the analysis and includes, but is not limited to: Purchase Location(s), If Multiple Prices and Purchase Dates. The “If Multiple Prices” option within the Required Data provides the user a mechanism to set a single Price for a single Product within the set of analyzed products. A User may select one of the following responses for “If Multiple Prices”: Highest Price, Lowest Price, Most Recent Price, Average Price, List Price or Mean Price. The remainder of the available segmentation criteria is customizable to the user's desire. In an embodiment, a preview of the number of products within the current segment according to the above criteria modifications may be presented to the user.

In an exemplary embodiment, once the criteria for the products to analyze and the products to consider as recommendations have been set by the user, multiple calculations are conducted by the Product Counsel Engine 1000 and presented to the user as a Summary Analysis 1040. In an embodiment, the user may order one or more products based on the Summary Analysis (step 1050—Order Products).

In an exemplary embodiment, one of the recommendations offered by the Product Counsel Engine 1000 is the Greatest Savings Recommendation. The Greatest Savings Recommendation analyzes each of the Related Products contained in the Product Details of each segmented product and conducts the following calculation: select the Related Product with the lowest Calculated Price and serve as the Greatest Savings Recommendation for the segmented product only if the Calculated Price of the selected Related Product is lower in value than the Calculated Price of the segmented product.

In an exemplary embodiment, multiple prices may exist for a single product within the date ranges provided by the user. In this case, the Product Counsel Engine 1000 uses the term Calculated Price for both the segmented product and Related Product based on the user selected option in the above criteria.

Furthermore, if the Calculated Price of the Product Counsel Engine 1000 chosen Related Product is lower in value than the Calculated Price of the segmented product, the Product Counsel Engine 1000 will present a Total Savings Potential to the user next to the Greatest Savings Recommended Product. The Total Savings Potential value is the difference between the Calculated Price of the segmented product multiplied by the Quantities Purchased of the segmented product over the specified period of time set in the criteria and the Calculated Price of the Product Counsel Engine 1000 chosen Related Product multiplied by the Quantities Purchased of the segmented product over the specified period of time set in the criteria.

In an exemplary embodiment, if no Related Product is found or if the observed Price is higher in value than the Calculated Price of the segmented Product, the Product Counsel Engine 1000 provides no recommendation.

In an exemplary embodiment, the above calculations are repeated for each segmented product being analyzed and the results of which are displayed back to the user 1044. The user may also export the Greatest Savings Recommendation (Step 1048—Export Analysis). Listed in the export and display is the Summary of the total calculation as well as a product-by-product display of the segmented product and the recommended Related Product, including the following Product Details for both the segmented product and the recommended Related Product: Product Number, Company, System, Description, Purchase Location and Calculated Price.

In an exemplary embodiment, another recommendation offer by the Product Counsel Engine 1000 is the Vendor Optimization analysis. The Vendor Optimization analysis seeks to uncover two key insights from the analyzed data: the percent of products offered by a Vendor (Company) that are related to the total segmented products analyzed, known as the Total Product Coverage Percentage, and the Total Company Conversion Differential of each Vendor.

In an exemplary embodiment, Vendor Optimization analyzes each of the Related Products contained in the Product Details of each segmented product and conducts the following calculation: select the Related Products with the lowest Calculated Price from each Company and serves as the Vendor Optimization selection(s) for each segmented product from step 1006. After each segmented product from step 1006 has been analyzed, the Product Counsel Engine 1000 will sum the total number of Related Products by Company and divide by the total number of segmented products. Companies will then be displayed in descending order of Coverage Percentage, the percentage of Related Products over the total number of segmented products. Furthermore, the Product Counsel Engine 1000 will calculate and present to the user a Total Conversion Differential by Vendor (Company).

In an exemplary embodiment, the Conversion Differential value is the difference between the Calculated Price of the segmented product multiplied by the Quantities Purchased of the segmented product over the specified period of time set in the criteria and the Calculated Price of the Product Counsel Engine 1000 chosen Related Product for each unique company found multiplied by the Quantities Purchased of the segmented product over the specified period of time set in the criteria. Conversion Differentials may be either positive or negative integers.

In an exemplary embodiment, if no Related Product is found the Product Counsel Engine 1000 provides no recommendation.

In an exemplary embodiment, the above calculations are repeated for each segmented product being analyzed from step 1006 and the sum of the Conversion Differential for each segmented product is known as the Total Company Conversion Differential, the results of which are displayed back to the user 1044. Companies will then be displayed in descending order of Total Conversion Differential, the difference in value of Related Products by company and value of the segmented products over the specified time period set in step 1006.

In an exemplary embodiment, the user may also export the Total Conversion Differential 1048. Listed in the export and display is the Summary of the total calculation as well as a product-by-product display of the segmented product and the recommended Related Product, including the following Product Details for both the segmented product and the recommended Related Product: Product Number, Company, System, Description, Purchase Location and Calculated Price.

In an exemplary embodiment, within the displayed results, the user will have the added ability to combine the results of one or more Company's Total Product Coverage Percentage to calculate a new Combined Company Product Coverage Percentage and new Combined Company Conversion Differential. In this scenario, only the Company of the Related Product with the lowest Calculated Price will be chosen as the single Related Product in both the Coverage Percentage and Conversion Differential Calculations.

In an exemplary embodiment, the user may also export the Combined Company Product Coverage Percentage and Combined Company Conversion Differential. Listed in the export and display is the Summary of the total calculation as well as a product-by-product display of the segmented product and the recommended Related Product, including the following Product Details for both the segmented product and the recommended Related Product: Product Number, Company, System, Description, Purchase Location and Calculated Price.

In an exemplary embodiment, another recommendation offer by the Product Counsel Engine 1000 is the Custom Product Counsel. The Custom Product Counsel displays each of the Related Products contained in the Product Details of each segmented product to the user. Accordingly, the user may make a selection of a product from the list of Related Products to view further details related to the selected product. The Custom Product Counsel will keep the segmented product as the selected product if no change in selection to a Related Product is made by the user. In an embodiment, the Custom Product Counsel displays the vendor market share and vendor spend associated with the selected product. In some embodiments, the Custom Product Counsel may include an indication in the display of Related Products to indicate the recommended products from the Great Savings Recommendation and the Vendor Optimization.

FIG. 11 illustrates an exemplary flow chart of the Inventory Engine of the system, according to some embodiments. The default Inventory screen for all users includes a summary view of each of the Inventory Locations that a user has been granted access to by the Admin user (step 1104). Each Inventory Location shown on this summary view provides the Inventory Location's Name, Address, Map, and Product Status Summary including the number of Recently Added Product Instances, the number of Expiring Product Instances, the number of Expired Product Instances, the number of Missing Product Instance as well as the number of Total Products Instances detected at this Inventory Location.

In an exemplary embodiment, to create an Inventory Location, the Admin user selects Create New Inventory Location (step 1110). The first step to create a new Inventory Location is to add a Name for the location as well as an Address (step 1112). The second step is to add at least one Device to the location (step 1114). A Device corresponds to AIDC-scanning capable hardware such as cabinets, vaults, portable totes or AIDC-scanning installations within a room, warehouse, stocking or distribution facilities that are networked to the cloud and accessible via internet via APIs or other data transfer means. Once the Inventory Location is created, the name, address, and associated devices may be modified, edited or deleted, at any time by the Admin user (step 1122).

In an exemplary embodiment, a displayed Inventory Location may be selected by any user to view the Inventory Location Details page that includes a Summary of all Products detected within the location (step 1120).

In an exemplary embodiment, the Inventory Location may be searched or filtered (step 1132) by any combination of Status 1134, Product Classifiers (as described in FIG. 7) 1136, Universal Classifiers (as described in FIG. 7) 1138, Tag(s) 1140, Product Number 1142, or Text 1146. As the system begins to search and/or filter the Inventory Location, real-time search results are displayed to the user. The search may be Reset at any time, returning a user to the all products display noted in 1120.

In an exemplary embodiment, Selecting a Product 1150 displays all the Product Instances 1154 of the selected product detected within the location 1130. Included in the display are all Product Details data and all Product Instance data. Any user with access to the Inventory Location may Claim a Product Instance so long as the Product Instance is currently Unclaimed 1158. Claiming a Product Instance reserves the Product Instance for the Claiming user for a period of time and the Claim may be canceled at any period of time before the Claim expires 1158.

FIG. 12 illustrates an exemplary flow chart of the Custody Engine of the system, according to some embodiments. Custody refers to current location of a Product Instance, however, instead of the location being an Inventory Location it is instead in the possession of an individual user of the system. The default Custody screen for all users displays Products in My Custody 1204, Claimed Products 1206, Pending Incoming Product Transfers 1224 and Pending Outgoing Product Transfers 1222.

In an exemplary embodiment, Selecting a Product (step 1208) from Products in My Custody (step 1204) displays all the Product Details data as well as the Product Instance(s) data of the selected Product (step 1208). In step 1210, any user may select at least one of the Product Instances displayed to either Add to a Usage Confirmation Submission or to Transfer to Another User.

In an exemplary embodiment, when a user adds a Product Instance to a Usage Confirmation, the Product Instance is added to a pending Usage Confirmation Cart (step 1214). The user may choose to proceed to filling out the remaining required information to complete the Usage Confirmation submission or the user may return to Products in My Custody 1204 to add additional Product Instances to the Usage Confirmation Cart prior to proceeding to Submit Usage Confirmation (step 1216). Any Product Instance added to a pending Usage Confirmation Cart may be removed at any time by the user (step 1214).

In an exemplary embodiment, when a user adds a Product Instance to the Transfer Product option, the Product Instance is added to a pending Product Transfer Cart (step 1220). The user may choose to proceed with a selection of a receiving party, another user within the system, to complete the Pending Outgoing Product Transfer or the user may return to Products in My Custody to add additional Product Instances to the pending Product Transfer Cart prior to proceeding with the receiving party selection.

In an exemplary embodiment, once a receiving party has been selected, the Product Instance enters the Pending Outgoing Transfers section of the user's Custody and will remain so until the receiving party either selects Accept Product Transfer or Deny Product Transfer (step 1222).

In an exemplary embodiment, when a receiving party selects Accept Product Transfer, the Product Instance(s) is moved from the transferring party's Pending Outgoing Transfers to the receiving party's Products in My Custody 1226. From the perspective of the receiving party, the Product Instance(s) is moved from Pending Incoming Product Transfers to the receiving party's Products in My Custody (step 1224).

In an exemplary embodiment, when a receiving party selects Deny Product Transfer, the Product Instance(s) is moved from the transferring party's Pending Outgoing Product Transfers to the transferring party's Products in My Custody (step 1226). From the perspective of the receiving party, the Product Instance(s) disappears from Pending Incoming Product Transfers (step 1224).

In an exemplary embodiment, any user may also manage how he or she is notified of Custody activity (step 1240). Custody activity may include Pending Incoming Product Transfers, Acceptance or Denial of Pending Outgoing Product Transfers, Product Custody Status warnings, and Product Custody time-in-possession warnings. Types of notifications include emails, texts, automated phone calls, in-app notifications, as well as push notifications in mobile application scenarios.

In an exemplary embodiment, any user may also view Other People's Custody based on the role of the user (step 1230). Representative and Manager users may view another Representative's Custody under a shared Manager 1250. Admin users may view all Representative's and Manager's Custody 1260.

FIG. 13 illustrates an exemplary flow chart of the Usage Confirmations Engine of the system, according to some embodiments. A Usage Confirmation is submitted by any user in the Custody feature set detailed in FIG. 12 when a product has been used. A Usage Confirmation includes, but is not limited to, the following information: Product Details for each product included and quantity of product(s) used, EPC, Lot Number, UDI Number, Date Submitted, Name of Submitter, Shipping Address of Submitter, Client, Client ID, Surgeon/Physician Name, Surgery Number, Procedure, and Notes.

In an exemplary embodiment, depending on the role of the user, Usage Confirmations are stored and by the Usage Confirmations Engine displayed in chronological order, descending in recency of submission (step 1304). A Representative may only view his or her submitted Usage Confirmations. A Manager may view all his or her associated Representative submitted Usage Confirmations. An Admin may view all submitted Usage Confirmations.

In an exemplary embodiment, due to the fact that several Usage Confirmations may exist within a short period of time, any user may search and/or filter the results using any combination the following criteria: Tag, Client, Lot Number, Surgeon/Physician Name, Date, Universal Classifiers (as described in FIG. 7), Product Classifiers (as described in FIG. 7), and Product ID 1312-1326. Users who are Manager role users have the additional criteria available to search and/or filter: by Representative 1310. Users that are Admin role users have the additional criteria available to search and/or filter: by Representative and Manager 1308-1310.

In an exemplary embodiment, Admins have the ability to Issue Product Reorders for Products (step 1330) within a submitted Usage Confirmation manually or automatically, sending an Order Request to a specified email address. In an embodiment, products may be automatically ordered based on the Usage Confirmation provided by the Admin and any invited user.

In an exemplary embodiment, a set of Notifications are customizable by user type within the Manage Notifications (step 1360) section of Usage Confirmations. For each available notification, Representative role users may choose the type(s) 1366—email, text, phone call, push notification—and the frequency of notifications (step 1368). Admin users may assign additional recipients to receive notifications for each available notification, in particular with Product Reorder Request notifications (step 1364).

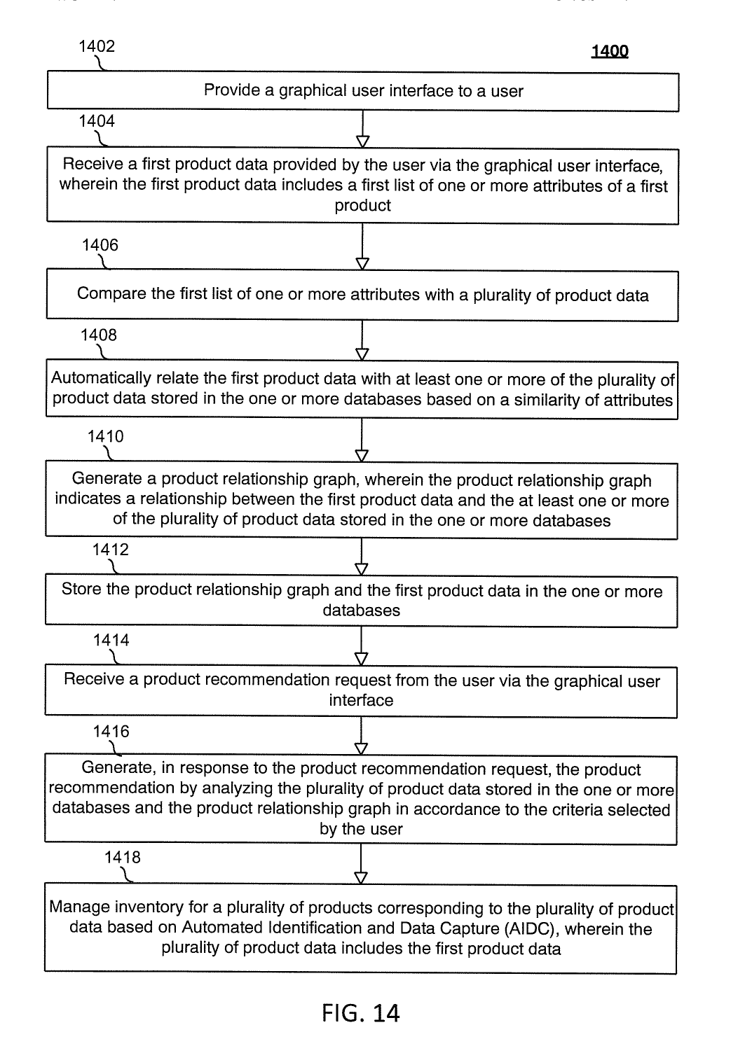

FIG. 14 illustrates a flow chart of a process for product relationship, recommendation, and inventory management, according to some embodiments. In some embodiments, the PRRIMS 400/500 performs process 1400 to analyze product relationship, generate a product recommendation, and manage inventory. In an embodiment, the PRRIMS 400/500 comprises one or more servers with a plurality of processors coupled to one or more databases to perform process 1400.

In step 1402, provide a graphical user interface to a user via an application server. Accordingly, a web-based application system for product relationship, recommendation, and inventory management, is provided to the user in the form of the graphical user interface and accessed through a web browser and/or a mobile application.

In step 1404, receive a first product data provided by the user via the graphical user interface. The first product data includes a first list of one or more attributes of the first product, wherein each attribute is associated with predefined classifications. In an embodiment, the predefined classifications may include any combination of Universal Classifiers (as described in FIG. 7), Order Classifiers (as described in FIG. 7), and Product Classifiers (as described in FIG. 7).

In step 1406, compare the first list of one or more attributes of the first product with a plurality of lists of one or more attributes for a plurality of product data stored in one or more databases. As described in FIG. 4, the first product data is compared based on the first list of one or more attributes with product data already stored in the Products Relationship Database, wherein the product data may be associated with products comprising relatable attributes with the first product.

In step 1408, automatically relate the first product data with at least one or more of the plurality of product data stored in the one or more databases based on a similarity of attributes. In an embodiment, the first list of attributes is automatically related to associated attributes included in product data already stored in the Products Relationship Database, thus enabling an indexed network system of interconnected products based on similar attributes.

In step 1410, generating a product relationship graph, wherein the product relationship graph indicates a relationship between the first product data and the at least one or more of the plurality of product data stored in the one or more databases. The product relationship graph contains information indicating the relationship between interconnected products, including the first product and the at least one or more products, based on similar attributes.

In step 1412, storing the product relationship graph and the first product data in the one or more databases.

In step 1414, receiving a product recommendation request from the user via the graphical user interface, wherein the product recommendation request comprises a criteria selected by the user for a product recommendation. As described above in FIG. 4, the user is prompted via the graphical user interface, to provide information through the Usage Form and the Consideration form, to set criteria for the product recommendation.

In step 1416, generating, in response to the product recommendation request, the product recommendation by analyzing the plurality of product data stored in the one or more databases and the product relationship graph in accordance to the criteria selected by the user. In an embodiment, the product recommendation may comprise an analysis based on cost efficiency and/or vendor optimization, as described in FIG. 10.

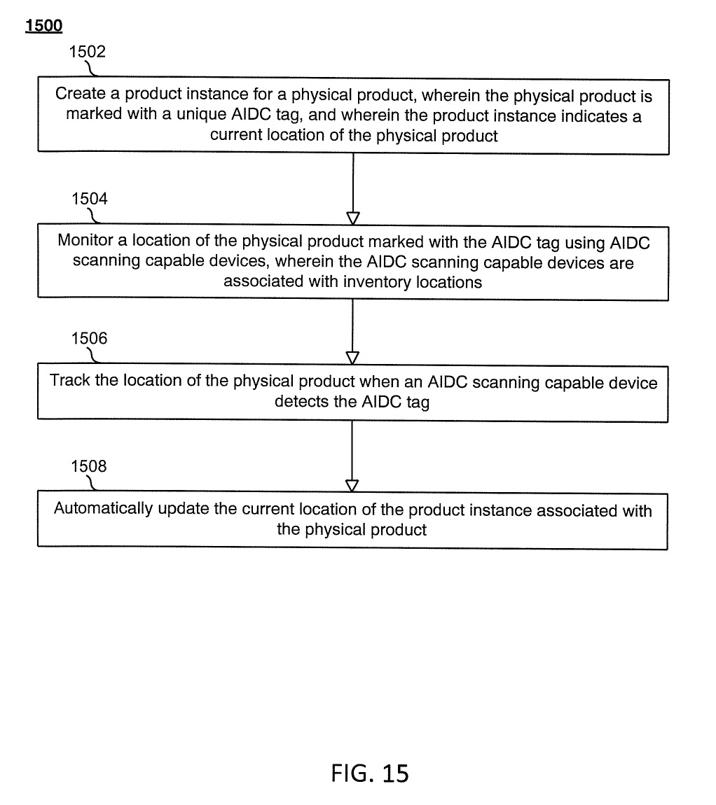

In step 1418, managing inventory for a plurality of physical products corresponding to the plurality of product data based on Automated Identification and Data Capture (AIDC), wherein the plurality of product data includes the received first product data. In an embodiment, the first product corresponding to the received first product data is properly marked with an AIDC tag or sticker and logically monitored through AIDC-scanning capable hardware. Accordingly, a current location of the first product can be digitally tracked by the user using a web browser/mobile application. This step of managing inventory will be described in further detail in the following FIG. 15.

FIG. 15 illustrates a flow chart of a process for product relationship, recommendation, and inventory management, according to some embodiments. In some embodiments, the PRRIMS 400/500 performs process 1500 to manage inventory of products stored in the product database. In an embodiment, the PRRIMS 400/500 comprises one or more servers with a plurality of processors coupled to one or more databases to perform process 1500.

In step 1502, creating a product instance for a physical product, wherein the physical product is marked with a unique AIDC tag, and wherein the product instance indicates a current location of the physical product. As described in FIG. 8, product instances are unique instances of a specific product marked with an AIDC tag which enables the remote tracking of the specific product with AIDC-scanning hardware as the product is moved between inventory locations. In an embodiment, products marked with a unique AIDC tag may be tracked when in a user's custody in between inventory locations. In an embodiment, the product instance further comprises information indicating the AIDC tag Electronic Product Code (EPC), the physical product's Expiration Date, and the physical product's Lot Number and UDI Number.

In step 1504, monitoring a location of the physical product marked with the AIDC tag using AIDC scanning capable devices, wherein the AIDC scanning capable devices are associated with inventory locations. The PRRIMS 400/500 continuously scans for signals transmitted by AIDC scanning capable devices upon detection of the physical product marked with the AIDC tag. In an embodiment, AIDC-scanning capable hardware includes, but is not restricted to, cabinets, vaults, portable totes or AIDC-scanning installations within a room, warehouse, stocking or distribution facilities that are networked to the cloud and accessible via internet via APIs or other data transfer means to establish and maintain communication with the PRRIMS 400/500.

In step 1506, tracking the location of the physical product when an AIDC scanning capable device detects the AIDC tag. In an embodiment, upon receipt of a signal transmitted by the AIDC scanning capable device indicating a detection of the physical product marked with the AIDC tag, the PRRIMS 400/500 determines the location of the AIDC scanning capable device and associates the determined location with a current location of the physical product. In another embodiment, the AIDC scanning capable device detects that the physical product is being moved out of an inventory to be used by a preauthorized user with an AIDC badge. In this case, the PRRIMS 400/500 determines that the physical product is no longer at an inventory location and in the custody of the preauthorized user with the AIDC badge.

In step 1508, automatically updating the current location of the product instance associated with the physical product. In an embodiment, the current location of the product instance may be displayed to a user through the graphical user interface. In another embodiment, the physical product may be in the custody of a preauthorized user. In this case, the current location of the product instance may indicate that the physical product is in the custody of the preauthorized user.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computerized method for product relationship, recommendation, and inventory management, the method comprising:
providing a graphical user interface to a user via an application server;
receiving a first product data provided by the user via the graphical user interface, wherein the first product data includes a first list of one or more attributes of a first product, and wherein each attribute is associated with predefined classifications;
comparing the first list of one or more attributes of the first product with a plurality of lists of one or more attributes for a plurality of product data stored in one or more databases;
automatically relating the first product data with at least one or more of the plurality of product data stored in the one or more databases based on a similarity of attributes;
generating a product relationship graph, wherein the product relationship graph indicates a relationship between the first product data and the at least one or more of the plurality of product data stored in the one or more databases;
storing the product relationship graph and the first product data in the one or more databases;
receiving a product recommendation request from the user via the graphical user interface, wherein the product recommendation request comprises a criteria selected by the user for a product recommendation;
generating, in response to the product recommendation request, the product recommendation by analyzing the plurality of product data stored in the one or more databases and the product relationship graph in accordance to the criteria selected by the user; and
managing inventory for a plurality of physical products corresponding to the plurality of product data based on Automated Identification and Data Capture, wherein the plurality of product data includes the received first product data, and wherein managing inventory for each of the plurality of physical products further comprising:
creating a product instance for a physical product, wherein the physical product is marked with a unique AIDC tag, and wherein the product instance indicates a current location of the physical product,
monitoring a location of the physical product marked with the AIDC tag using AIDC scanning capable devices, wherein the AIDC scanning capable devices are associated with inventory locations,
tracking the location of the physical product when an AIDC scanning capable device detects the AIDC tag, and
automatically updating the current location of the product instance associated with the physical product.

2. The computerized method of claim 1, wherein managing inventory for each of the plurality of physical products further comprises:
recording a usage confirmation of the physical product, wherein the usage confirmation is provided by a preauthorized user.

3. The computerized method of claim 2, wherein managing inventory for each of the plurality of physical products further comprises:
automatically ordering one or more products based on the product usage confirmation provided by the preauthorized user.

4. The computerized method of claim 1, wherein the predefined classifications are modified and additional classifications are added to the predefined classifications by the user.

5. The computerized method of claim 1, wherein the predefined classifications include one or more of tag(s), product number, text, universal classifiers, order classifiers, and product classifiers.

6. The computerized method of claim 1, further comprising:
receiving a request from the user to view the plurality of product data on the one or more databases; and
in response to the request, displaying a list of the plurality of product data to the user through the graphic user interface.

7. The computerized method of claim 6, further comprising:
receiving a request from the user to modify a product data from the list of the plurality of product data; and
modifying the product data in the one or more databases.

8. The computerized method of claim 1, wherein creating the product instance for the selected product further comprising:
scanning an electronic product code for the unique AIDC tag; and
inputting the physical product expiration date, lot number, and Universal Device Identification number.

9. The computerized method of claim 1, wherein the product recommendation request further comprises past purchase data regarding the first product.

10. The computerized method of claim 9, wherein the product recommendation comprises an analysis based on cost efficiency.

11. The computerized method of claim 9, wherein the product recommendation comprises an analysis based on vendor optimization.

12. The computerized method of claim 2, wherein the usage confirmation includes one or more of: quantity of product(s) used, Electronic Product Code, lot number, Universal Device Identification number, date submitted, name of submitter, shipping address of submitter, client, client identification, surgeon/physician name, surgery number, procedure, and notes.

13. A system for product relationship, recommendation, and inventory management, the system comprising:
an application server configured to provide a graphical user interface to a user; and
a processing server coupled to the application server and comprising one or more processors, the processing server configured to:
receive a first product data provided by the user via the graphical user interface, wherein the first product data includes a first list of one or more attributes of a first product, and wherein each attribute is associated with predefined classifications;
compare the first list of one or more attributes of the first product with a plurality of lists of one or more attributes for a plurality of product data stored in one or more databases;
automatically relate the first product data with at least one or more of the plurality of product data stored in the one or more databases based on a similarity of attributes;
generate a product relationship graph, wherein the product relationship graph indicates a relationship between the first product data and the at least one or more of the plurality of product data stored in the one or more databases;
store the product relationship graph and the first product data in the one or more databases;
receive a product recommendation request from the user via the graphical user interface, wherein the product recommendation request comprises a criteria selected by the user for a product recommendation;
generate, in response to the product recommendation request, the product recommendation by analyzing the plurality of product data stored in the one or more databases and the product relationship graph in accordance to the criteria selected by the user; and
manage inventory for a plurality of physical products corresponding to the plurality of product data based on Automated Identification and Data Capture, wherein the plurality of product data includes the received first product data, and wherein managing inventory for each of the plurality of physical products further comprising:
create a product instance for a physical product, wherein the physical product is marked with a unique AIDC tag, and wherein the product instance indicates a current location of the physical product,
monitor a location of the physical product marked with the AIDC tag using AIDC scanning capable devices, wherein the AIDC scanning capable devices are associated with inventory locations,
track the location of the physical product when an AIDC scanning capable device detects the AIDC tag, and
automatically update the current location of the product instance associated with the physical product.

14. The system of claim 13, wherein managing inventory for each of the plurality of physical products further comprises:
record a usage confirmation of the physical product, wherein the usage confirmation is provided by a preauthorized user.

15. The system of claim 14, wherein managing inventory for each of the plurality of physical products further comprises:
automatically ordering one or more products based on the product usage confirmation provided by the preauthorized user.

16. The system of claim 13, wherein the predefined classifications are modified and additional classifications are added to the predefined classifications by the user.

17. The system of claim 13, wherein the predefined classifications include one or more of tag(s), product number, text, universal classifiers, order classifiers, and product classifiers.

18. The system of claim 13, wherein the processing server is further configured to:
receive a request from the user to view the plurality of product data on the one or more databases; and
in response to the request, display a list of the plurality of product data to the user through the graphic user interface.

19. The system of claim 18, further comprising:
receive a request from the user to modify a product data from the list of the plurality of product data; and
modify the product data in the one or more databases.

20. The system of claim 13, wherein creating the product instance for the selected product further comprising:
scan an electronic product code for the unique AIDC tag; and
input the physical product expiration date, lot number, and Universal Device Identification number.

21. The system of claim 13, wherein the product recommendation request further comprises past purchase data regarding the first product.

22. The system of claim 21, wherein the product recommendation comprises an analysis based on cost efficiency.

23. The system of claim 21, wherein the product recommendation comprises an analysis based on vendor optimization.

24. The system of claim 14, wherein the usage confirmation includes one or more of: quantity of product(s) used, Electronic Product Code, lot number, Universal Device Identification number, date submitted, name of submitter, shipping address of submitter, client, client identification, surgeon/physician name, surgery number, procedure, and notes.

25. A computer program product comprising a non-transitory computer readable medium storing a computer program for product relationship, recommendation, and inventory management, said computer program comprises code which when run by a processor causes the processor to:
provide a graphical user interface to a user;
receive a first product data provided by the user via the graphical user interface, wherein the first product data includes a first list of one or more attributes of a first product, and wherein each attribute is associated with predefined classifications;
compare the first list of one or more attributes of the first product with a plurality of lists of one or more attributes for a plurality of product data stored in one or more databases; automatically relate the first product data with at least one or more of the plurality of product data stored in the one or more databases based on a similarity of attributes;
generate a product relationship graph, wherein the product relationship graph indicates a relationship between the first product data and the at least one or more of the plurality of product data stored in the one or more databases;
store the product relationship graph and the first product data in the one or more databases;
receive a product recommendation request from the user via the graphical user interface, wherein the product recommendation request comprises a criteria selected by the user for a product recommendation;
generate in response to the product recommendation request, the product recommendation by analyzing the plurality of product data stored in the one or more databases and the product relationship graph in accordance to the criteria selected by the user and manage inventory for a plurality of physical products corresponding to the plurality of product data based on Automated Identification and Data Capture, wherein the plurality of product data includes the received first product data, and wherein managing inventory for each of the plurality of physical products further comprising:
create a product instance for a physical product, wherein the physical product is marked with a unique AIDC tag, and wherein the product instance indicates a current location of the physical product,
monitor a location of the physical product marked with the AIDC tag using AIDC scanning capable devices, wherein the AIDC scanning capable devices are associated with inventory locations,
track the location of the physical product when an AIDC scanning capable device detects the AIDC tag, and
automatically update the current location of the product instance associated with the physical product.
